(19) United States
(12) Patent Application Publication
(10) Pub. No.: US 2010/0247771 A1
(43) Pub. Date: Sep. 30, 2010

(54) INKJET RECORDING METHOD

(75) Inventor: Masamichi KOBAYASHI, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/730,272

(22) Filed: Mar. 24, 2010

(30) Foreign Application Priority Data
Mar. 31, 2009 (JP) 2009-088299

(51) Int. Cl. B05D 5/12

(52) U.S. Cl. 427/256

(57) ABSTRACT

The present invention provides an inkjet recording method including a step of recording an image by an inkjet method using at least an ink containing from 0.1% by mass to 1.0% by mass of a betaine compound on an inkjet recording medium including, on a support, an ink receiving layer containing from 0.05 g/m² to 0.5 g/m² of a betaine compound and from 0.1 g/m² to 0.5 g/m² of an inorganic mordant, with which high-humidity blurring is suppressed and printing defects and coating failure are suppressed.

### CROSS-REFERENCE TO RELATED APPLICATION

This application claims priority under 35 USC 119 from Japanese Patent Application No. 2009-088299 filed on Mar. 31, 2009, the disclosure of which is incorporated by reference herein.

### BACKGROUND OF THE INVENTION

1. Field of the Invention

The present invention relates to an inkjet recording method.

2. Related Art

In recent years, along with rapid development in the information industry, a variety of information processing systems have been developed, and recording methods and recording devices suitable for the respective information processing systems have also been developed and put to practical use. Among these recording methods, an inkjet recording method has been widely used not only in offices but also in private homes, because the inkjet recording method has the advantages that the method allows recording on a variety of recording media, hardware (apparatus) is relatively inexpensive and compact, the method is excellent in terms of quietness, and the like.

Further, along with the recent trend in inkjet printers toward higher definition and the recent development of hardware (apparatus), various kinds of media for use in inkjet recording (hereinafter, also referred to as “inkjet recording media”) are being developed and, more recently, it has become possible to obtain photograph-like high-quality recorded materials.

Specifically, an inkjet recording medium is generally required to have properties such as (1) quick-drying properties (high ink absorption rate), (2) appropriate and uniform ink dot diameter (without ink blur), (3) excellent granularity, (4) high dot circularity, (5) high color density, (6) high saturation (without dullness), (7) excellent light fastness, gas resistance, and water resistance of a printed image portion, (8) a high degree of whiteness of a recording face, (9) excellent storability of a recording medium (absence of yellowing and image blurring during long-term storage), (10) resistance to deformation and excellent dimensional stability (sufficiently low curling), and (11) excellent traveling properties within hardware.

Further, with regard to photographic glossy paper which is used for obtaining photograph-like high-quality recorded materials, properties such as glossiness, surface smoothness, texture similar to that of silver salt photographic paper, and the like are also required in addition to the properties above.

Recently, a variety of studies have been made with respect to an ink receiving layer of an inkjet recording medium.

For example, an inkjet recording method including adding a betaine compound to both an ink and an ink receiving layer, for the purpose of suppression of high-humidity blurring and improvement in resistance to climatic conditions, is known (see, for example, Japanese Patent Application Laid-Open (JP-A) No. 2005-111699).

Further, an inkjet recording sheet which has an ink receiving layer including an inorganic mordant and a betaine surfactant, for the purpose of suppression of high-humidity blurring, is known (see, for example, JP-A No. 2004-122520).

### SUMMARY OF THE INVENTION

However, the present inventors have found that printing defects occur when a large amount of betaine compound is added to an ink, and that failure in coating of an ink receiving layer sometimes occurs when a large amount of betaine compound is added to an ink receiving layer including an inorganic mordant.

The present invention has been made in view of the above circumstances, and an object of the invention is to provide an inkjet recording method with which high-humidity blurring is suppressed and printing defects and coating failure are suppressed. More specifically, an aspect of the present invention provides an inkjet recording method including: a step of recording an image by an inkjet method using at least an ink including 0.1% by mass to 1.0% by mass of a betaine compound onto an inkjet recording medium having, on a support, an ink receiving layer comprising 0.05 g/m² to 0.5 g/m² of a betaine compound and 0.1 g/m² to 0.5 g/m² of an inorganic mordant.

### DETAILED DESCRIPTION OF THE INVENTION

The objects to solve the problems may be achieved by items <1> to <14> shown below.
<1> An inkjet recording method including: a step of recording an image by an inkjet method using at least an ink including from 0.1% by mass to 1.0% by mass of a betaine compound on an inkjet recording medium including, on a support, an ink receiving layer including from 0.05 g/m² to 0.5 g/m² of a betaine compound and from 0.1 g/m² to 0.5 g/m² of an inorganic mordant.
<2> The inkjet recording method of the item <1>, wherein the ink is a magenta ink.
<3> The inkjet recording method of the items <1> or <2>, wherein each of the betaine compound included in the ink receiving layer and the betaine compound included in the ink is a betaine surfactant including an oil-soluble group.
<4> The inkjet recording method of any one of the items <1> to <3>, wherein a cationic moiety of the betaine compound included in the ink receiving layer and a cationic moiety of the betaine compound included in the ink each includes a nitrogen atom of amine, a nitrogen atom of a hetero-aromatic ring, a quaternary nitrogen atom, a boron atom that has four bonds each connected with a carbon atom, or a phosphorous atom that has four bonds each connected with a carbon atom.
<5> The inkjet recording method of any one of the items <1> to <3>, wherein the betaine compound included in the ink receiving layer and the betaine compound included in the ink are compounds represented by the following Formula (B1):

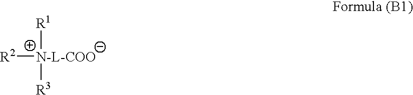

In Formula (B1), R¹, R² and R³ each independently represent an alkyl group, an aryl group or a heterocyclic group; R¹ to R³ are capable of linking together to form a cyclic structure; and L represents a bivalent linkage group.
<6> The inkjet recording method of any one of the items <1> to <3>, wherein the betaine compound included in the ink receiving layer and the betaine compound included in the ink are compounds represented by the following Formula (B2):

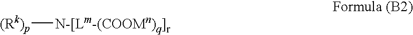

In Formula (B2), R^{k} represents an unsubstituted or substituted alkyl group having 1 to 20 carbon atoms, an unsubstituted or substituted aryl group having 6 to 20 carbon atoms or an unsubstituted or substituted heterocyclic group having 2 to 20 carbon atoms; (R^{k})s are capable of linking together to form a cyclic structure; L^{m} represents a bivalent linkage group; Mⁿ represents a hydrogen atom, an alkali metal ion, an ammonium ion, an organic cation of amine or a quaternary ammonium ion; p is an integer of 0 to 3; q is an integer of 1 or more; r is an integer of 1 to 4; and p+r is 3 or 4.
<7> The inkjet recording method of the item <6>, wherein a group represented by R^{k} or L^{m} includes a hydrocarbon group having 8 to 20 carbon atoms.
<8> The inkjet recording method of any one of the items <1> to <7>, wherein the inorganic mordant is a compound including aluminum, a compound including titanium, a compound including zirconium or a metal compound including an element belonging to Group IIIB of the periodic table.
<9> The inkjet recording method of any one of the items <1> to <7>, wherein the inorganic mordant is a water soluble zirconium compound.
<10> The inkjet recording method of the item <2>, wherein the magenta ink includes a dye represented by the following Formula (M):

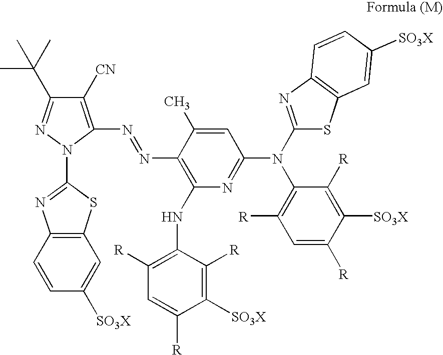

In Formula (M), the plural Rs each independently represent a methyl group, an ethyl group, an isopropyl group or a tert-butyl group; X represents Li, Na or K; each R may be the same as or different from another R; and each X may be the same as or different from another X.

The inkjet recording method of the present invention includes a step of recording an image by an inkjet method using at least an ink containing 0.1% by mass to 1.0% by mass of a betaine compound onto an inkjet recording medium having, on a support, an ink receiving layer containing 0.05 g/m² to 0.5 g/m² of a betaine compound and 0.1 g/m² to 0.5 g/m² of an inorganic mordant.

In general, high-humidity blurring (blurring under an environment of high humidity) may be suppressed by incorporating a betaine compound into an ink receiving layer or an ink. Further, high-humidity blurring may also be suppressed by incorporating an inorganic mordant into an ink receiving layer.

However, when a large amount of betaine compound is added to an ink, foaming of ink may occur (for example, at the time of filling the cartridge with the ink, or the like) to cause printing defects. Furthermore, in the case where the above ink is a magenta ink, magenta image density becomes low.

When a large amount of betaine compound is added to a coating liquid for the ink receiving layer including an inorganic mordant, coating failure may occur at the time of coating to form the ink receiving layer. In addition, in a cyan image formed onto the receiving layer by using a cyan ink (irrespective of including a betaine compound or not), ozone resistance may be deteriorated.

According to the inkjet recording method of the present invention having the configuration described above, high-humidity blurring is suppressed and printing defects and coating failure are suppressed. Furthermore, ozone resistance of a cyan image formed by using a cyan ink (irrespective of including a betaine compound or not) is improved.

Particularly, when a magenta ink is prepared as the ink containing 0.1% by mass to 1.0% by mass of a betaine compound and used, a high magenta image density can be obtained.

Furthermore, the present inventors have found that, according to the inkjet recording method of the invention, an effect of reducing odor that is provided at the time of drying of images can be obtained in addition to the effects described above by adding a betaine compound to an ink and an ink receiving layer.

Owing to the recent evolution of inks, ink receiving layers, and inkjet recording devices, high-speed printing has advanced, but on the contrary, the odor that is provided at the time of drying of images becomes a problem in some cases.

Therefore, the inkjet recording method of the present invention is preferable also from the viewpoint of suppression of the odor at the time of drying of images.

The inkjet system in the invention (hereinafter, referred to as the “inkjet recording system” in some cases) is not limited, and any known systems can be used.

Examples of the known systems include: a charge control system in which ink is ejected by using an electrostatic attraction force; a drop-on-demand system (pressure pulse system) in which a vibration pressure of a piezo element is used; an acoustic inkjet system in which an electric signal is converted into an acoustic beam and an ink is irradiated with the acoustic beam so as to be ejected by using the radiation pressure; and a thermal inkjet (BUBBLE JET (registered trade name)) system in which an ink is heated to form bubbles and the resulting pressure is used.

The inkjet recording system include: a system of ejecting a number of droplets of a low concentration ink, which is referred to as photo ink, at a small volume; a system of improving the image quality by using plural inks which have substantially the same hue but different concentrations; and a system of using transparent and colorless ink. The volume of an ink droplet to be spotted is mainly controlled by a print head.

For example, in the case of a thermal inkjet system, the volume of an ink droplet to be spotted can be controlled by the structure of the print head. Specifically, by changing the size of an ink chamber, a heating unit or a nozzle, ink droplets can be spotted at a desired size. Further, in the case of a thermal inkjet system as well, by using plural print heads having heating units or nozzles of different sizes, it is possible to realize spotting ink droplets of plural sizes.

In the case of a drop-on-demand system using a piezo element, it is possible to change the volume of ink droplets to be spotted similar to the case of a thermal inkjet system from the structural point of view, but by controlling the waveform of the drive signal which drives the piezo element, ink droplets of plural sizes can be spotted from the print heads having the same structure.

In the inkjet recording method of the invention, an average spotting speed when ink droplets are spotted onto the recording medium is preferably set at 2 m/sec or higher, and more preferably 5 m/sec or higher.

The spotting speed may be controlled by, for example, controlling the shape and amplitude of the waveform that drives the print head.

In addition, by using plural drive waveforms properly, ink droplets of plural sizes can be spotted from the same print head.

In the following, the inkjet recording medium used for the inkjet recording method of the present invention is explained, and then, the ink is explained.

<<Inkjet Recording Medium>>

The inkjet recording medium in the present invention has, on a support, an ink receiving layer containing 0.05 g/m² to 0.5 g/m² of a betaine compound and 0.1 g/m² to 0.5 g/m² of an inorganic mordant.

In the present invention, when the content of the betaine compound in the ink receiving layer exceeds 0.5 g/m², coating failure of the ink receiving layer may be deteriorated. Further, when the content of the betaine compound in the ink receiving layer exceeds 0.5 g/m², ozone resistance of a cyan image may be deteriorated.

From the viewpoint of suppression of high-humidity blurring, the ink receiving layer needs to substantially contain a betaine compound. Specifically, the content of the betaine compound in the ink receiving layer is 0.05 g/m² or more.

From the viewpoints of suppression of high-humidity blurring, suppression of coating failure, and improvement in ozone resistance of a cyan image, the content of the betaine compound in the ink receiving layer is preferably from 0.05 g/m² to 0.4 g/m², and more preferably from 0.1 g/m² to 0.3 g/m².

In the present invention, when the content of the inorganic mordant in the ink receiving layer exceeds 0.5 g/m², coating failure of the ink receiving layer may be deteriorated.

From the viewpoint of suppression of high-humidity blurring, the ink receiving layer needs to substantially contain an inorganic mordant. Specifically, the content of the inorganic mordant in the ink receiving layer is 0.1 g/m² or more.

From the viewpoints of suppression of high-humidity blurring and suppression of coating failure, the content of the inorganic mordant in the ink receiving layer is preferably from 0.1 g/m² to 0.4 g/m², and more preferably from 0.1 g/m² to 0.3 g/m².

In the following, first, the betaine compound and the inorganic mordant are explained, and then, the ink receiving layer and the support are explained.

<Betaine Compound>

The betaine compound in the present invention is not particularly limited, but is preferably a betaine surfactant having an oil-soluble group.

The betaine compound that is preferably used in the present invention is a betaine surfactant having surface active performance.

The betaine surfactant used herein refers to a compound having both of a cationic moiety and an anionic moiety in a molecular thereof.

Examples of the cationic moiety include a nitrogen atom of amine, a nitrogen atom of a hetero-aromatic ring, a quaternary nitrogen atom, a boron atom that has four bonds each connected with a carbon atom, and a phosphorous atom that has four bonds each connected with a carbon atom. Among them, a nitrogen atom of amine, a nitrogen atom of a hetero-aromatic ring, and a quaternary nitrogen atom are preferable, and a quaternary nitrogen atom is particularly preferable.

Examples of the anionic moiety include a hydroxy group, a thio group, a sulfonamido group, a sulfo group, a carboxy group, an imido group, a phosphoric acid group, and a phosphonic acid group. Among them, a carboxy group and a sulfo group are particularly preferable.

The charge of the whole molecule of a betaine compound (preferably, a betaine surfactant) may be any of cation, anion, or neutral, but is preferably neutral.

In particular, a compound represented by either of the following Formula (B1) or the following Formula (B2) (particularly preferably, a compound represented by the following Formula (B1)) is preferably used as the betaine compound used for the present invention.

(Compound Represented by Formula (B1))

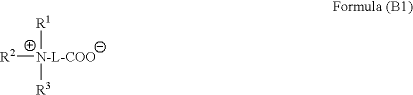

In Formula (B1), R¹ to R³ each independently represent an alkyl group (which may be substituted. A group having 1 to 20 carbon atoms is preferable, and examples include a methyl group, an ethyl group, a propyl group, a butyl group, a hexyl group, an octyl group, a dodecyl group, a cetyl group, a stearyl group, an oleyl group, and the like.), an aryl group (which may be substituted. A group having 6 to 20 carbon atoms is preferable, and examples include a phenyl group, a tolyl group, a xylyl group, a naphthyl group, a cumyl group, a dodecylphenyl group, and the like.), or a heterocyclic group (which may be substituted. A group having 2 to 20 carbon atoms is preferable, and examples include a pyridyl group, a quinolyl group, and the like.). R¹ to R³ are capable of linking together to form a cyclic structure.

R¹ to R³ are each particularly preferably an alkyl group.

In Formula (B1), L represents a bivalent linkage group.

L is preferably a bivalent linkage group containing an alkylene group or an arylene group as a fundamental constituent unit. A heteroatom such as an oxygen atom, a sulfur atom, or a nitrogen atom may be included in the linkage main chain portion.

In Formula (B1), R¹ to R³ or L may be substituted with various substituents. For example, an alkyl group (preferably, having 1 to 20 carbon atoms, more preferably 1 to 12 carbon atoms, and particularly preferably 1 to 8 carbon atoms, and examples include methyl, ethyl, isopropyl, tert-butyl, n-octyl, n-decyl, n-hexadecyl, cyclopropyl, cyclopentyl, cyclohexyl, and the like), an alkenyl group (preferably, having 2 to 20 carbon atoms, more preferably 2 to 12 carbon atoms, and particularly preferably 2 to 8 carbon atoms, and examples include vinyl, allyl, 2-butenyl, 3-pentenyl, and the like), an alkynyl group (preferably, having 2 to 20 carbon atoms, more preferably 2 to 12 carbon atoms, and particularly preferably 2 to 8 carbon atoms, and examples include propargyl, 3-pentynyl, and the like), an aryl group (preferably, having 6 to 30 carbon atoms, more preferably 6 to 20 carbon atoms, and particularly preferably 6 to 12 carbon atoms, and examples include phenyl, p-methylphenyl, naphthyl, and the like), an amino group (preferably, having 0 to 20 carbon atoms, more preferably 0 to 12 carbon atoms, and particularly preferably 0 to 6 carbon atoms, and examples include amino, methylamino, dimethylamino, diethylamino, diphenylamino, dibenzylamino, and the like), an alkoxy group (preferably, having 1 to 20 carbon atoms, more preferably 1 to 12 carbon atoms, and particularly preferably 1 to 8 carbon atoms, and examples include methoxy, ethoxy, butoxy, and the like), an aryloxy group (preferably, having 6 to 20 carbon atoms, more preferably 6 to 16 carbon atoms, and particularly preferably 6 to 12 carbon atoms, and examples include phenyloxy, 2-naphthyloxy, and the like),

an acyl group (preferably, having 1 to 20 carbon atoms, more preferably 1 to 16 carbon atoms, and particularly preferably 1 to 12 carbon atoms, and examples include acetyl, benzoyl, formyl, pivaloyl, and the like), an alkoxycarbonyl group (preferably, having 2 to 20 carbon atoms, more preferably 2 to 16 carbon atoms, and particularly preferably 2 to 12 carbon atoms, and examples include methoxycarbonyl, ethoxycarbonyl and the like), an aryloxycarbonyl group (preferably, having 7 to 20 carbon atoms, more preferably 7 to 16 carbon atoms, and particularly preferably 7 to 10 carbon atoms, and examples include phenyloxycarbonyl, and the like), an acyloxy group (preferably, having 2 to 20 carbon atoms, more preferably 2 to 16 carbon atoms, and particularly preferably 2 to 10 carbon atoms, and examples include acetoxy, benzoyloxy, and the like),

an acylamino group (preferably, having 2 to 20 carbon atoms, more preferably 2 to 16 carbon atoms, and particularly preferably 2 to 10 carbon atoms, and examples include acetylamino, benzoylamino and the like), an alkoxycarbonylamino group (preferably, having 2 to 20 carbon atoms, more preferably 2 to 16 carbon atoms, and particularly preferably 2 to 12 carbon atoms, and examples include methoxycarbonylamino, and the like), an aryloxycarbonylamino group (preferably, having 7 to 20 carbon atoms, more preferably 7 to 16 carbon atoms, and particularly preferably 7 to 12 carbon atoms, and examples include phenyloxycarbonylamino, and the like), a sulfonylamino group (preferably, having 1 to 20 carbon atoms, more preferably 1 to 16 carbon atoms, and particularly preferably 1 to 12 carbon atoms, and examples include methanesulfonylamino, benzenesulfonylamino, and the like),

a sulfamoyl group (preferably, having 0 to 20 carbon atoms, more preferably 0 to 16 carbon atoms, and particularly preferably 0 to 12 carbon atoms, and examples include sulfamoyl, methylsulfamoyl, dimethylsulfamoyl, phenylsulfamoyl, and the like), a carbamoyl group (preferably, having 1 to 20 carbon atoms, more preferably 1 to 16 carbon atoms, and particularly preferably 1 to 12 carbon atoms, and examples include carbamoyl, methylcarbamoyl, diethylcarbamoyl, phenylcarbamoyl, and the like), an alkylthio group (preferably, having 1 to 20 carbon atoms, more preferably 1 to 16 carbon atoms, and particularly preferably 1 to 12 carbon atoms, and examples include methylthio, ethylthio, and the like), an arylthio group (preferably, having 6 to 20 carbon atoms, more preferably 6 to 16 carbon atoms, and particularly preferably 6 to 12 carbon atoms, and examples include phenylthio, and the like), a sulfonyl group (preferably, having 1 to 20 carbon atoms, more preferably 1 to 16 carbon atoms, and particularly preferably 1 to 12 carbon atoms, and examples include mesyl, tosyl, and the like), a sulfonyl group (preferably, having 1 to 20 carbon atoms, more preferably 1 to 16 carbon atoms, and particularly preferably 1 to 12 carbon atoms, and examples include methanesulfinyl, benzenesulfinyl, and the like),

a ureido group (preferably, having 1 to 20 carbon atoms, more preferably 1 to 16 carbon atoms, and particularly preferably 1 to 12 carbon atoms, and examples include ureido, methylureido, phenylureido, and the like), a phosphoric acid amide group (preferably, having 1 to 20 carbon atoms, more preferably 1 to 16 carbon atoms, and particularly preferably 1 to 12 carbon atoms, and examples include diethylphosphoric acid amide, phenylphosphoric acid amide, and the like), a hydroxy group, a mercapto group, a halogen atom (for example, a fluorine atom, a chlorine atom, a bromine atom, and an iodine atom), a cyano group, a sulfo group, a carboxy group, a nitro group, a hydroxamic acid group, a sulfino group, a hydrazino group, an imino group, a heterocyclic group (preferably, having 1 to 30 carbon atoms, and more preferably 1 to 12 carbon atoms, and containing, for example, a nitrogen atom, an oxygen atom or a sulfur atom as the heteroatom. Specific examples include imidazolyl, pyridyl, quinolyl, furyl, thienyl, piperidyl, morpholino, benzoxazolyl, benzimidazolyl, benzothiazolyl, carbazolyl, azepinyl, and the like),

a silyl group (preferably, having 3 to 40 carbon atoms, more preferably 3 to 30 carbon atoms, and particularly preferably 3 to 24 carbon atoms, and examples include trimethylsilyl, triphenylsilyl, and the like), and the like may be mentioned.

These substituents may be further substituted. In the case of having two or more substituents, the substituents may be identical or different. Furthermore, if possible, the substituents may be linked to each other to form a ring. Plural betaine structures may also be included by linking together through R¹ to R³ or L.

It is preferable that the compound represented by the formula (B1) that is used in the invention contain a group having 8 or more carbon atoms for any of the groups represented by R¹ to R³ and L. Among them, it is particularly preferable that a long-chain alkyl group (for example, an alkyl group having 8 to 30 carbon atoms, more preferably 8 to 20 carbon atoms) is contained in at least one of R¹ to R³.

(Compound Represented by Formula (B2))

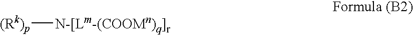

In Formula (B2), R^{k} represents an alkyl group which may be substituted. A group having 1 to 20 carbon atoms is preferable, and examples include a methyl group, an ethyl group, a propyl group, a butyl group, a hexyl group, an octyl group, a dodecyl group, a cetyl group, a stearyl group, an oleyl group, and the like.), an aryl group (which may be substituted. A group having 6 to 20 carbon atoms is preferable, and examples include a phenyl group, a tolyl group, a xylyl group, a naphthyl group, a cumyl group, a dodecylphenyl group, and the like.), or a heterocyclic group (which may be substituted. A group having 2 to 20 carbon atoms is preferable, and examples include a pyridyl group, a quinolyl group, and the like.). (R^{k})s are capable of linking together to form a cyclic structure. R^{k} is particularly preferably an alkyl group.

In Formula (B2), L^{m} represents a linkage group having a valency of two or more. Specifically, L^{m} is preferably a linkage group having a valency of two or more and containing an alkylene group or an arylene group as a fundamental constituent unit. A heteroatom such as an oxygen atom, a sulfur atom, or a nitrogen atom may be included in the linkage main chain portion.

In Formula (B2), R^{k} and L^{m} may have various substituents.

Examples of the substituents are substantially similar to those exemplified as the substituents with respect to R¹ to R³ or L in Formula (B1).

The substituents may be further substituted. In the case of having two or more substituents, the substituents may be identical or different. If possible, the substituents are capable of linking together to form a ring. Further, plural betaine structures may be included by linking together through R^{k} or L^{m}.

In Formula (B2), Mⁿ represents a hydrogen atom, an alkali metal ion (for example, a sodium ion, a potassium ion, a lithium ion, or a cesium ion), an ammonium ion, or an organic cation of amine (in the case of primary to tertiary amine, it represents a protonized one, for example, protonized methylamine, protonized dimethylamine, protonized ethylamine, protonized diethylamine, protonized triethylamine, protonized diazabicycloundecene, protonized diazabicyclooctane, protonized piperidine, protonized pyrrolidine, protonized morpholine, protonized N-methylpiperidine, protonized N-methylmorpholine, protonized pyridine, protonized pyrazine, protonized aniline, protonized N,N-dimethylaniline, or the like; and in the case of quaternary ammonium salt, it represents, for example, a tetramethylammonium ion, a tetraethylammonium ion, a trimethylbenzylammonium ion, a methylpyridinium ion, a benzylpyridinium ion, or the like). Among them, an alkali metal ion or a hydrogen atom is particularly preferable.

In Formula (B2), q represents an integer of 1 or more, and r represents an integer of from 1 to 4.

In Formula (B2), p represents an integer of from 0 to 3, and p+r=3 or 4. When p+r=4, the nitrogen atom (N atom) is a protonized ammonium atom (═N⁺═).

Here, p+r=3 is preferable.

In Formula (B2), when q is 2 or more, (COOMⁿ)s may be the same or different from each other.

In Formula (B2), when r is 2 or more, [L^{m}-(COOMⁿ)_{q}]s may be the same or different from each other. When p is 2 or more, (R^{k})s may be the same or different from each other.

Further, it is preferred that, in Formula (B2), a hydrocarbon group having 8 to 30 carbon atoms be contained in at least R^{k} or L^{m}, and it is more preferred that a hydrocarbon group having 8 to 20 carbon atoms be contained in at least R^{k} or L^{m}.

As the compound represented by Formula (B2), a compound represented by the following Formula (B3) is most preferably used.

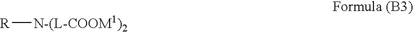

In Formula (B3), R and L have the same definitions as R and L in Formula (B2), respectively.

In Formula (B3), M¹ represents an alkali metal ion or a hydrogen atom.

Examples of the betaine compound in the invention are shown below, but the invention is not limited to these examples.

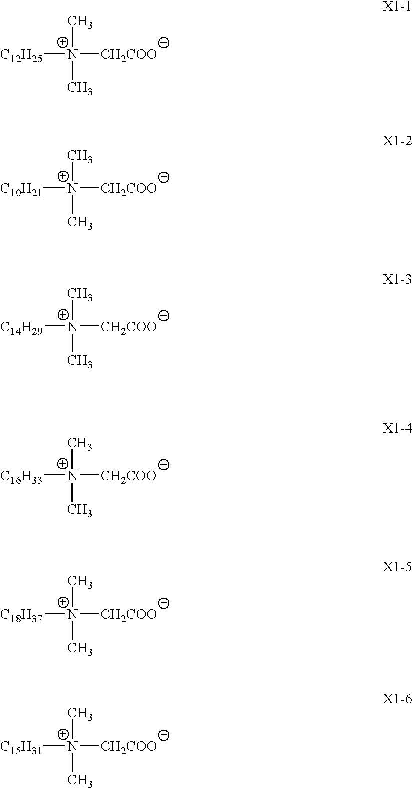

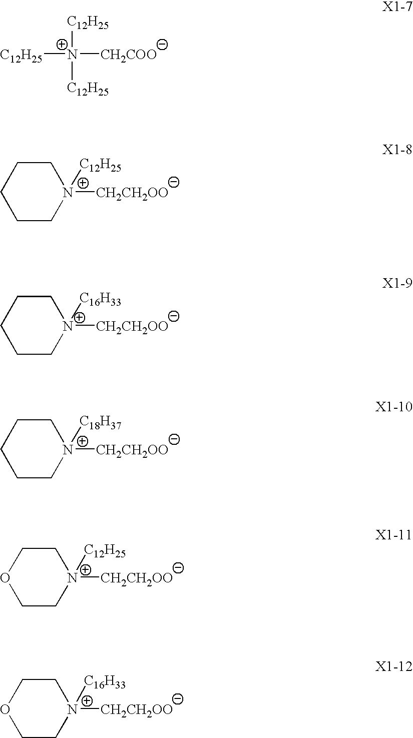

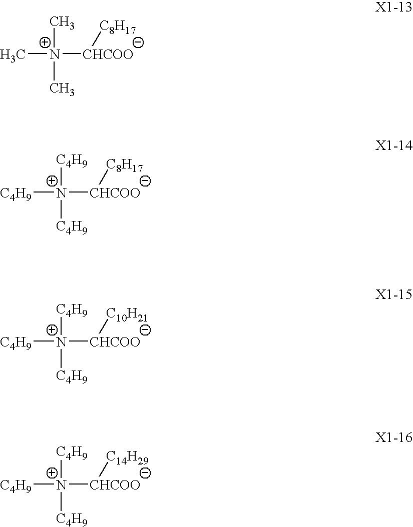

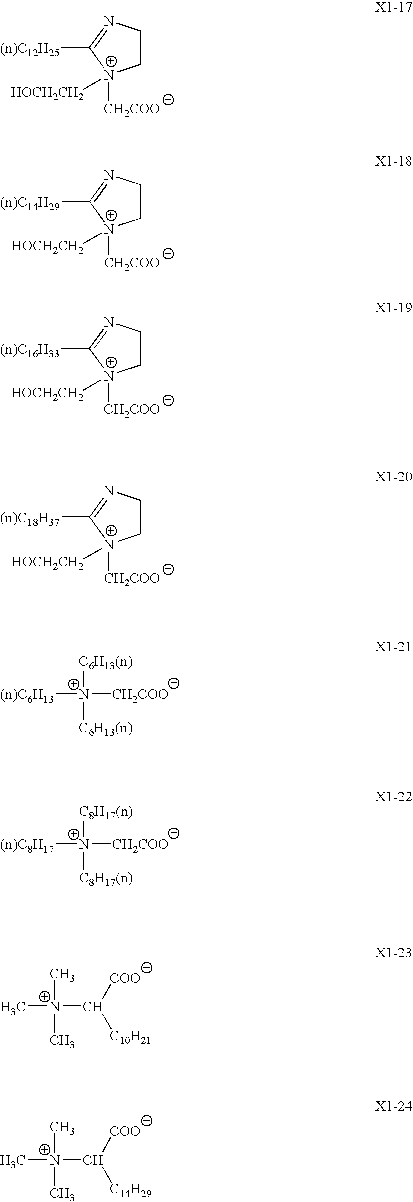

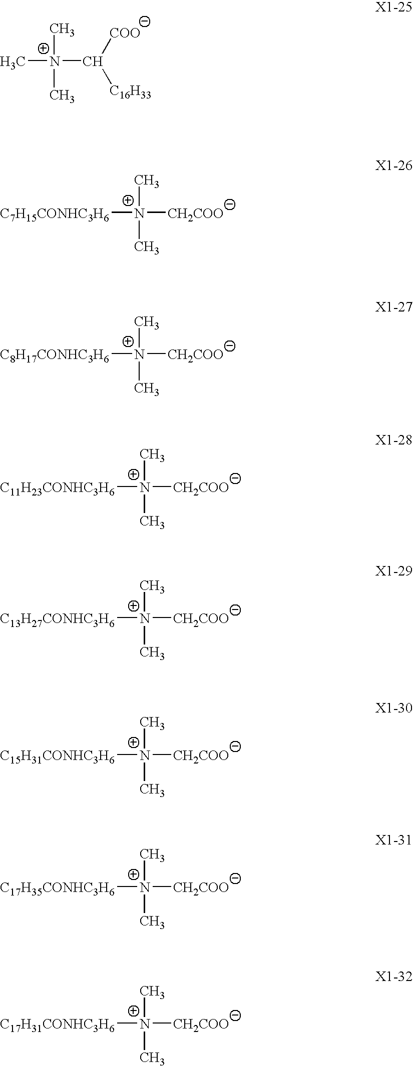

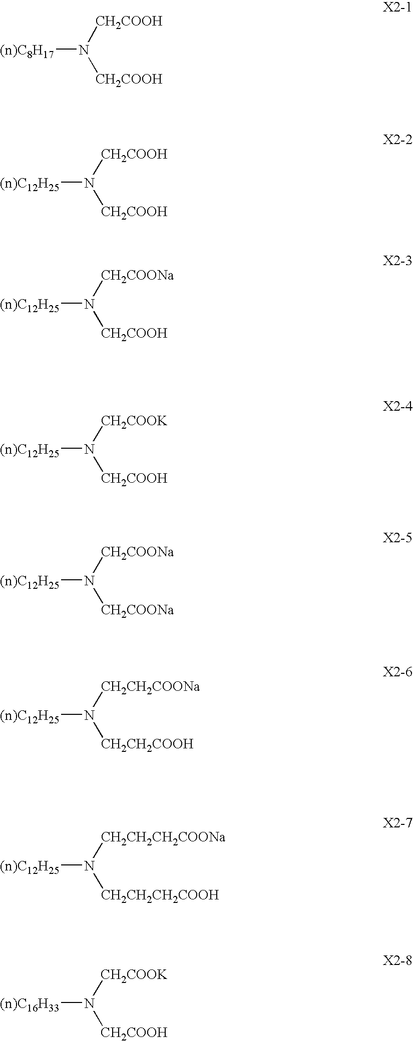

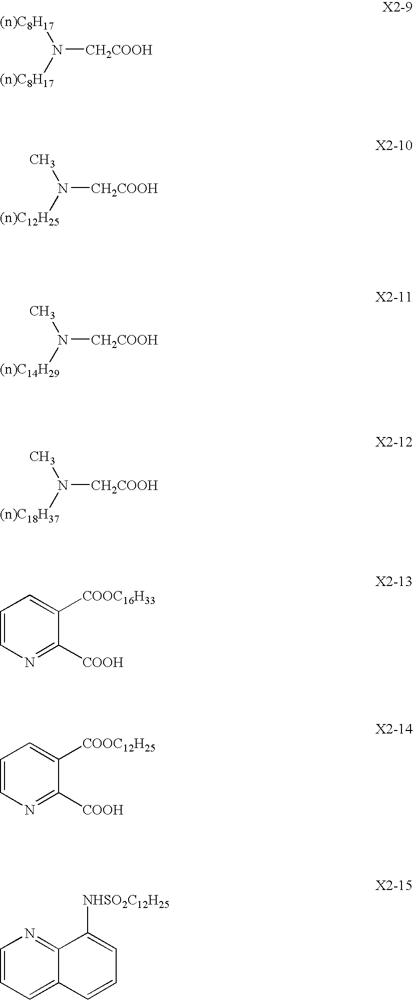

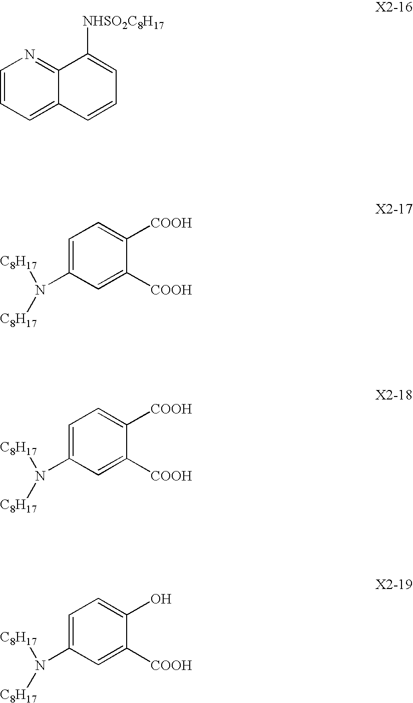

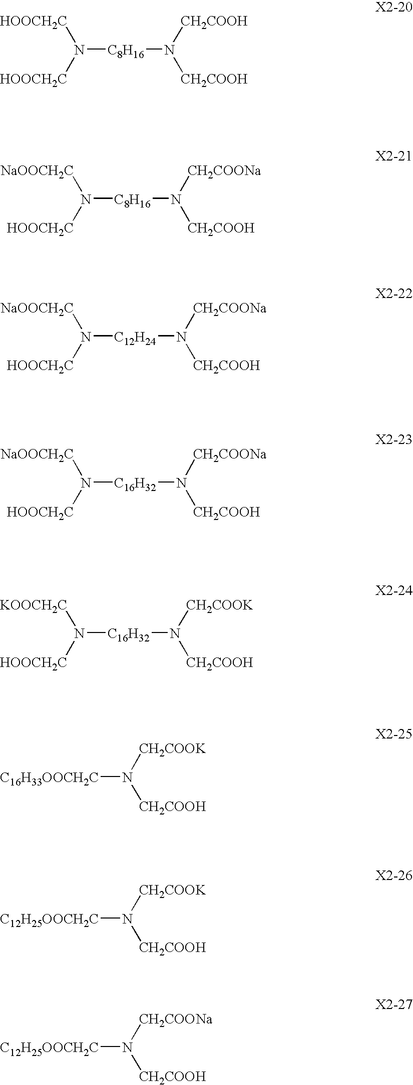

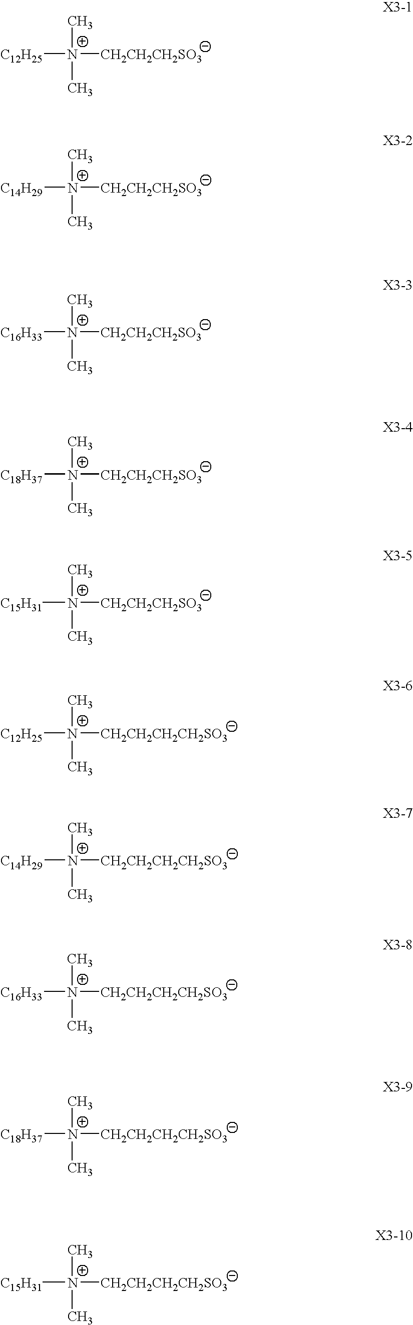

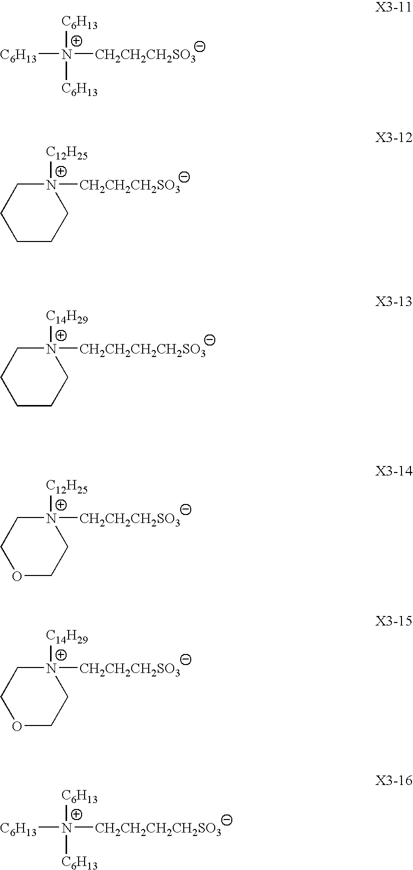

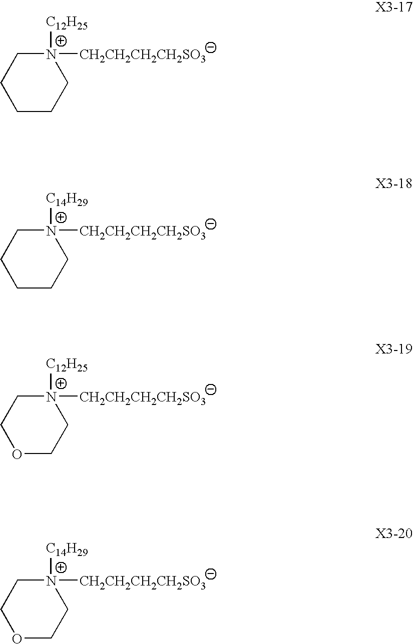

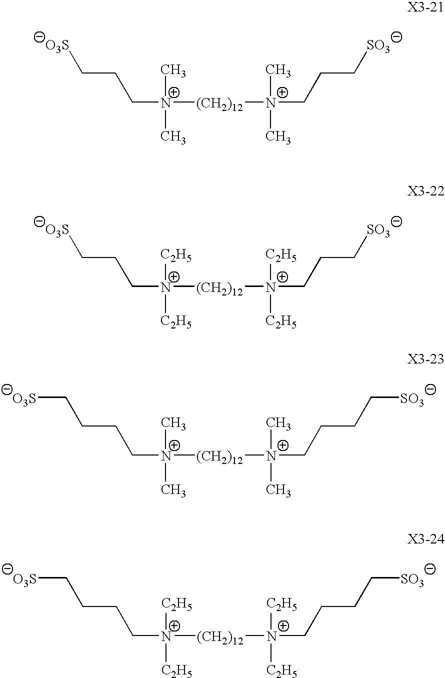

### <Inorganic Mordant>

The ink receiving layer in the invention contains an inorganic mordant.

By the existence of an inorganic mordant in the ink receiving layer, high-humidity blurring can be suppressed.

Further, the inorganic mordant interacts with an ink having an anionic dye as a coloring material to be able to stabilize the coloring material, whereby water resistance can be improved, and aging-induced blurring can be suppressed.

In the invention, the inorganic mordants may be used alone or may be used in combination.

Further, in the invention, the inorganic mordant may be used in combination with an organic mordant.

The inorganic mordant used in the invention refers to a metal compound which has solubility with respect to an ink for inkjet recording and is capable of forming a metal ion having a characteristic of mordant. As the metal compound, a water soluble one and a hydrophobic one are described. The metal compound is preferably a salt or a complex, and more preferably a salt or complex of a polyvalent metal.

Specific examples of the inorganic mordant include salts or complexes of a metal selected from the group consisting of magnesium, aluminum, calcium, scandium, titanium, vanadium, chromium, manganese, iron, cobalt, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten, and bismuth.

Specifically, examples thereof include calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, copper(II) chloride, ammonium copper(II) chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum alum, basic polyaluminum hydroxide, aluminum sulfite, aluminum thiosulfate, polyaluminum chloride, aluminum nitrate nonahydrate, aluminum chloride hexahydrate, iron(II) bromide, iron(II) chloride, iron(III) chloride, iron(II) sulfate, iron(III) sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, ammonium zirconium carbonate, zirconyl stearate, zirconyl octylate, zirconyl nitrate, zirconium oxychloride, zirconium hydroxychloride, chromium acetate, chromium sulfate, magnesium sulfate, magnesium chloride hexahydrate, magnesium citrate nonahydrate, sodium phosphorustungstate, sodium tungsten citrate, 12 tungstophosphoric acid n-hydrate, 12 tungstosilicic acid 26 hydrate, molybdenum chloride, 12 molybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, and bismuth nitrate.

The inorganic mordant used in the present invention is preferably a compound including aluminum, a compound including titanium, a compound including zirconium, or a metal compound including an element belonging to Group IIIB of the periodic table.

<Ink Receiving Layer>

The ink receiving layer in the present invention is preferably constituted by including a pigment and a water soluble resin in addition to the inorganic mordant and betaine compound described above.

The ink receiving layer according to the invention is constituted by one layer or by two or more layers.

From the viewpoint of more effectively realizing the effects of the invention, the ink receiving layer has a layer thickness (total layer thickness in the case of two or more layers) of 10 μm to 50 μm, and more preferably 20 μm to 40 μm.

(Pigment)

As the pigment, white pigment is preferable. Examples of the white pigment include inorganic white pigments such as calcium carbonate, kaolin, talc, clay, diatomaceous earth, synthetic amorphous silica, aluminum silicate, magnesium silicate, calcium silicate, aluminum hydroxide, alumina (for example, boehmite alumina, pseudo-boehmite alumina, or the like), lithopone, zeolite, barium sulfate, calcium sulfate, titanium dioxide, zinc sulfide, and zinc carbonate, organic pigments such as styrene-based pigment, acrylic pigment, urea resin, and melamine resin, and the like.

Particularly, porous inorganic white pigments are preferable, and synthetic amorphous silica having a large specific surface area is particularly preferable.

The synthetic amorphous silica (hereinafter, referred to as the “silica fine particles” in some cases) includes anhydrous silica which is obtained by a dry manufacturing method (vapor-phase process) and hydrated silica which is obtained by a wet manufacturing method, and any of these may be used.

Concerning the recording paper (inkjet recording medium) which has an ink receiving layer including the above pigment, specifically, those disclosed in JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314, and the like may be used.

—Silica Fine Particles—

Silica fine particles are preferably used as the pigment in the ink receiving layer.

Because the silica fine particles have a particularly large specific surface area, the silica fine particles have high ink absorptivity and high efficiency of ink retention. Further, because the silica fine particles have a low refraction index, when dispersion is carried out to an extent that an appropriate fine particle diameter is obtained, the ink receiving layer may be made transparent, and there is an advantage that high color density and satisfactory coloring property are obtained. As such, the fact that the ink receiving layer is transparent is important from the viewpoint of obtaining high color density, satisfactory coloring property, and satisfactory glossiness, for example, in the case of application to recording sheets such as photographic glossy paper and the like.

The average primary particle diameter of the inorganic fine particles such as silica fine particles is preferably 20 nm or less, more preferably 15 nm or less, and particularly preferably 10 nm or less. When the average primary particle diameter is 20 nm or less, ink absorption characteristics can be effectively improved and, at the same time, glossiness of the surface of the ink receiving layer can be enhanced.

The specific surface area of the inorganic fine particles determined by BET method is preferably 200 m²/g or more, more preferably 250 m²/g or more, and particularly preferably 380 m²/g or more. When the specific surface area of the inorganic fine particles is 200 m²/g or more, the ink receiving layer has high transparency and can maintain high image density.

The BET method as referred to in the present description is a method for measuring a surface area of a powder by a vapor-phase adsorption method. This method finds a total surface area of 1 g of a sample, that is, a specific surface area from an adsorption isotherm. Nitrogen gas is most often used as the adsorption gas, and the adsorbed amount of gas is most often measured from the pressure or volume variations of the adsorption gas. An equation suggested by Brunauer, Emmett, and Teller, which is called a BET equation, is the most famous equation representing an isotherm of multimolecular adsorption and it is widely used for determining the surface area. A surface area can be found by finding the adsorption amount based on the BET equation and multiplying by the area taken by one adsorbed molecule on the surface.

Because the silica fine particles, in particular, have silanol groups on their surfaces, the particles easily adhere to each other through hydrogen bonding of the silanol groups, and there is an effect of adhesion between the particles through the silanol groups and the water soluble resin. Hence, when the average primary particle diameter of silica fine particles is 20 nm or less as described above, the porosity of the ink receiving layer is high, a structure with high transparency can be formed, and ink absorption characteristics can be effectively improved.

Silica fine particles are usually roughly classified into wet method particles and dry method (vapor-phase process) particles in accordance with the method for manufacturing thereof. In the mainstream of the wet method, silica fine particles are mainly produced by generating an activated silica by acid decomposition of a silicate, appropriately polymerizing the activated silica, and aggregation precipitation of the resulting polymeric silica to obtain hydrated silica. On the other hand, in the mainstream of the vapor-phase process, silica (anhydrous silica) particles are produced by either a method having high-temperature vapor-phase hydrolysis of a silicon halide (flame hydrolysis process), or a method having reductively heating and vaporizing quartz sand and coke in an electric furnace, applying an arc discharge and oxidizing the vaporized silica with air (arc method). The “vapor-phase process silica” means an anhydrous silica fine particle produced by the vapor-phase process.

While the above vapor-phase process silica differs from hydrated silica in terms of the density of silanol groups on its surfaces, the presence or absence of voids therein, and the like, and exhibits different properties from hydrated silica, vapor-phase process silica is suitable for forming a three-dimensional structure which has a high porosity. While the reason for this is not clearly understood, it can be supposed as follows. Namely, hydrated silica fine particles have a high density of silanol groups on the surface, at from 5 per nm² to 8 per nm², thus the silica fine particles tend to coagulate (aggregate) densely. In contrast, vapor-phase process silica particles have a lower density of silanol groups on the surface, at from 2 per nm² to 3 per nm², thus vapor-phase process silica seems to form less compact, loose coagulations (flocculations), consequently leading to a structure with a higher porosity.

In the present invention, vapor-phase process silica fine particles (anhydrous silica) which can be obtained by the dry method are preferable, and silica fine particles having a density of silanol groups on the surface at from 2 per nm² to 3 per nm² are more preferable.

The inorganic fine particles most preferably used in the present invention are vapor-phase process silica having a specific surface area of 200 m²/g or more as determined by the BET method.

—Pseudo-Boehmite Alumina—

Pseudo-boehmite alumina is also preferably used as the pigment in the ink receiving layer.

The pseudo-boehmite alumina (pseudo-boehmite alumina hydrate) is represented by the following structural formula:

Al₂O₃.nH₂O (1<n<3)

and means an alumina hydrate in which n is more than 1 but less than 3 in the structural formula.

Examples of the pseudo-boehmite alumina which can be preferably used include pseudo-boehmite alumina described in paragraphs [0027] to [0040] in JP-A No. 2008-246755.

(Water Soluble Resin)

Examples of the water soluble resin include polyvinyl alcohol resins having hydroxy groups as a hydrophilic structural unit (for example, polyvinyl alcohol (PVA), acetoacetyl-modified polyvinyl alcohol, cation-modified polyvinyl alcohol, anion-modified polyvinyl alcohol, silanol-modified polyvinyl alcohol and polyvinyl acetal), cellulose resins (for example, methyl cellulose (MC), ethyl cellulose (EC), hydroxyethyl cellulose (HEC), carboxymethyl cellulose (CMC), hydroxypropyl cellulose (HPC), hydroxyethyl methyl cellulose and hydroxypropyl methyl cellulose), chitins, chitosans, starch, resins having ether bonds (for example, polyethylene oxide (PEO), polypropylene oxide (PPO), and polyvinyl ether (PVE)), resins having carbamoyl groups (for example, polyacrylamide (PAAM), polyvinyl pyrrolidone (PVP) and polyacrylic acid hydrazide).

Those having carboxy groups as dissociation groups, such as polyacrylic acid, maleic acid resins, alginic acid, gelatin and salts thereof, may also be mentioned.

Among the above polymers, polyvinyl alcohol resins are particularly preferable. Examples of the polyvinyl alcohol resins are described in Japanese Patent Application Publication (JP-B) Nos. 4-52786, 5-67432 and 7-29479, Japanese Patent No. 2537827, JP-B No. 7.57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, JP-A Nos. 2000-158801, 2001-213045, 2001-328345, 8-324105 and 11-348417.

Compounds described in paragraphs [0011′] to [0014] in JP-A No. 11-165461 may also be mentioned as examples of water soluble resins other than polyvinyl alcohol resins.

These water soluble resins may be used alone, or in a combination of two or more of them.

The content of the water soluble resin of the invention is preferably 9% by mass to 40% by mass and is more preferably 12% by mass to 33% by mass, with respect to the total solid content of the ink receiving layer.

The water soluble resin and the vapor-phase process silica that mainly constitute the ink receiving layer of the invention may be comprised of a single material, or may be a mixed material of plural materials, respectively.

From the viewpoints of maintaining transparency and improving image density, the type of the water soluble resin to be combined with the vapor-phase process silica is important. Polyvinyl alcohol resin is preferable as the water soluble resin. Among these, polyvinyl alcohol resin with a saponification degree of from 70% to 100% is preferable, polyvinyl alcohol resin with a saponification degree of 80% to 99.5% is more preferable, and polyvinyl alcohol resin with a saponification degree of 82% to 90% is particularly preferable.

The polyvinyl alcohol resins have hydroxy groups in their respective structural units, and hydrogen bonds are formed between these hydroxy groups and silanol groups present on the surfaces of the vapor-phase process silica; as a result, it becomes easy to form a three-dimensional network structure having secondary particles of silica fine particles as network chain units. It is thought that formation of such a three-dimensional network structure allows the ink receiving layer formed to have a porous structure of a high porosity and sufficient strength.

When inkjet recording is performed, the porous ink receiving layer formed in the foregoing manner can quickly absorb ink through capillary action and form dots of high circularity without generating ink bleeding.

The polyvinyl alcohol resin may be used in combination with other water soluble resins. When another water soluble resin is used in combination with the polyvinyl alcohol resin, the content of the polyvinyl alcohol resin is preferably 50% by mass or more, and more preferably 70% by mass or more with respect to the total mass of water soluble resins used in the ink receiving layer.

(Ratio of Pigment Content to Water Soluble Resin Content)

The ratio of the pigment content (x) by mass to the water soluble resin content (y) by mass [PB ratio (x/y): a mass of a pigment per one part by mass of a water soluble resin] may affect significantly to the film structure and film strength of the ink receiving layer. In a larger content ratio [PB ratio (x/y)], a lager porosity, a bigger volume of fine pore, and a bigger surface area (per mass unit) of the ink receiving layer may be obtained. Specifically, the PB ratio (x/y) is preferably in a range of from 1.5 to 10 from the viewpoints of preventing a decrease in film strength and the appearance of cracks under drying, which are caused by excessively high PB ratios, and avoiding a reduction in ink absorptivity by a decrease in porosity resulting from a tendency to pores being clogged by the resins, which develops when PB ratios are excessively low.

At the time of passage through the transfer system of an inkjet printer, the inkjet recording medium is subjected to stress in some cases, so the ink receiving layer is preferable to have sufficient film strength. In addition, from the standpoint of avoiding the occurrence of cracking and exfoliation in the ink receiving layer when the recording medium is cut into sheets, the ink receiving layer is preferable to have sufficient film strength. In view of these cases, the PB ratio (x/y) is preferably 5 or less, while it is preferably 2 or more from the viewpoint of ensuring quick ink absorptivity in inkjet printer.

For example, when a coating liquid prepared by completely dispersing vapor-phase process silica fine particles having an average primary particle diameter of 20 nm or less and polyvinyl alcohol with a high saponification degree at a PB ratio (x/y) of 2 to 5 is applied onto a support and dried, a three-dimensional network is formed having secondary particles of the silica fine particles as network chains, whereby a light-transmitting porous film having an average pore diameter of 30 nm or less, a porosity of 50% to 80%, a specific pore volume of 0.5 ml/g or more, and a specific surface area of 100 m²/g or more can be easily formed.

The ink receiving layer may include additives other than the pigment and the water soluble resin, such as a crosslinking agent, an organic mordant, a water resistance imparting agent, a light fastness enhancing agent, a gas resistance enhancing agent, a surfactant, a hardener, and other additives.

As the crosslinking agent, a crosslinking agent that is capable of crosslinking a water soluble resin (for example, polyvinyl alcohol) may be used, and, for example, crosslinking agents (for example, boric acid, boric acid salts, and the like) described in paragraphs [0061] to [0065] in JP-A No. 2007-223119 may be preferably used.

Examples of the organic mordant which can be preferably used include polyallylamine, derivatives thereof, and organic mordants described in paragraphs [0023] to in JP-A No. 2004-122520.

As the water resistance imparting agent, light fastness enhancing agent, gas resistance enhancing agent, and surfactant, for example, each of the components described in paragraphs [0418] to [0420] in JP-A No. 2005-111699 can be preferably used.

As the hardener, materials described on page 222 in JP-A No. 1-161236, and in JP-A Nos. 9-263036, 10-119423, and 2001-310547, and the like can be used.

As the other additives that may be added to the ink receiving layer, there may be mentioned a pigment dispersing agent, a viscosity increasing agent, a defoaming agent, a dye, a fluorescent whitening agent, an antiseptic agent, a pH adjusting agent, a matting agent, and the like.

<Support and the Like>

As the support according to the present invention, ones that are made of chemical pulp such as LBKP or NBKP, mechanical pulp such as GP, PGW, RMP, TMP, CTMP, CMP, or CGP, or waste paper pulp such as DIP, to which, as needs arise, additives such as a conventionally known pigment, binder, sizing agent, fixing agent, cationic agent, and paper strength intensifying agent are added and mixed, and manufactured using various kinds of apparatuses such as a Fourdrinier paper machine or a cylinder paper machine, and the like are mentioned. Other than these supports, the support of the invention may be any of a synthetic paper and a plastic film sheet. It is preferred that the support have a thickness of 10 μm to 250 μm and have a basis weight of 10 g/m² to 250 g/m².

The inkjet recording medium of the present invention may be formed by disposing an ink receiving layer or a back coat layer on the support as it is, or a recording medium may be formed by disposing a size press or anchor coat layer using starch, polyvinyl alcohol, or the like on the support, and then disposing thereon an ink receiving layer or a back coat layer. Further, the support may be subjected to a flattening treatment by means of a calender device, such as a machine calender, a TG calender, or a soft calender.

In the present invention, a paper whose two surfaces are covered with polyolefin (for example, polyethylene, polystyrene, polybutene, or a copolymer thereof) or polyethylene terephthalate or a plastic film is more preferably used as the support. It is preferable to add a white pigment (for example, titanium oxide or zinc oxide) or a dye for tinting (for example, cobalt blue, ultramarine blue, or neodymium oxide) into the polyolefin.

The inkjet recording medium in the invention may be provided with a back coat layer. Further, a polymer fine particle dispersion may be added to the ink receiving layer or the back coat layer.

For the back coat layer or the polymer fine particle dispersion, materials described, for example, in paragraphs [0423] to [0425] in JP-A No. 2005-111699 may be used.

<Method for Forming Ink Receiving Layer and the Like>

There is no particular limitation on the method for forming the ink receiving layer, and, for example, a known method, in which a coating liquid for an ink receiving layer containing each of the components of the ink receiving layer described above and a solvent such as water or the like is coated on a resin layer and dried, may be used.

Preparation of the coating liquid for an ink receiving layer may be carried out by adding all of the components at the same time, or may be carried out by first preparing a pigment dispersion containing a pigment, and then adding the other components to the prepared pigment dispersion.

The ink receiving layer forming step may be carried out by coating one coating liquid containing all of the components and then drying, or may be carried out by coating two or more coating liquids and then drying. In the latter case, the two or more coating liquids are prepared by dividing the components of the ink receiving layer among the two or more coating liquids, and then the two or more coating liquids are subjected to successive coating or simultaneous multilayer coating, followed by drying. Concerning the method of coating two or more coating liquids, there may be used, other than the successive coating and the simultaneous multilayer coating, for example, “Wet-On-Wet method” described in paragraphs [0016] to [0037] in JP-A No. 2005-14593.

Examples of a disperser to be used for dispersing the pigment include various kinds of conventionally known dispersers such as a high speed rotating type disperser, a medium stirring type disperser (for example, a ball mill, a bead mill a sand mill, or the like), a ultrasonic disperser, a colloid mill disperser and a high pressure disperser. In order to efficiently disperse lumpy particles which generate during dispersion, a medium stirring type disperser, a colloid mill disperser or a high pressure disperser (homogenizer) is preferable. Mainly, a medium stirring type disperser such as a bead mill is preferably used as the disperser, but from the viewpoints of acceleration of fine graining and high maximum density, high pressure homogenizer (for example, ULTIMIZER (trade name), manufactured by Sugino Machine Limited; or the like) is particularly preferable.

As a solvent used in preparation of a coating liquid for an ink receiving layer, water, an organic solvent, or a mixed solvent thereof may be used. Examples of the organic solvent usable in the coating include alcohols such as methanol, ethanol, n-propanol, i-propanol or methoxy propanol, ketones such as acetone or methyl ethyl ketone, tetrahydrofuran, acetonitrile, ethyl acetate, and toluene.

Coating of the coating liquid for an ink receiving layer may be performed by using a known coating device such as an extrusion die coater, air doctor coater, blade coater, rod coater, knife coater, squeeze coater, reverse roll coater and bar coater.

The coating described above may be carried out by inline-mixing an aqueous solution of basic polyaluminum hydroxide with the coating liquid for the ink receiving layer.

As a method for drying the coated layer obtained by the above coating, a known method of drying by blowing a dry air can be used without any particular limitation.

<<Ink>>

The inkjet recording method of the present invention uses at least one kind of ink containing 0.1% by mass to 1.0% by mass of a betaine compound.

The betaine compound included in the ink may be substantially the same as the betaine compound included in the ink receiving layer.

In the invention, the betaine compound in the ink and the betaine compound in the ink receiving layer may be of the same kind or different kinds.

When the content of the betaine compound in the ink exceeds 1.0% by mass, for example, foaming of ink may occur, and printing defects may occur. In particular, in the case where the ink is a magenta ink, when the content of the betaine compound in the magenta ink exceeds 1.0% by mass, magenta image density may become low.

Further, from the viewpoint of suppression of high-humidity blurring, the ink needs to substantially contain a betaine compound. Specifically, the content of the betaine compound in the ink is 0.1% by mass or higher.

From the viewpoints of suppression of high-humidity blurring and suppression of printing defects, (and further, from the viewpoint of improvement in magenta image density with regard to a magenta ink), the content of the betaine compound in the ink is preferably from 0.1% by mass to 0.9% by mass, more preferably from 0.1% by mass to 0.7% by mass, and even more preferably from 0.1% by mass to 0.6% by mass.

Particularly, from the viewpoint of further effectively suppressing the high-humidity blurring, the range in which the lower limit in each of the above ranges is made to be 0.3% by mass (more preferably, 0.4% by mass) is preferable.

In the inkjet recording method of the invention, an ink containing 0.1% by mass to 1.0% by mass of a betaine compound and an ink containing a betaine compound in an amount of less than 0.1% by mass (for example, an ink which does not contain a betaine compound) may be used in combination.

In the invention, the ink containing a betaine compound may be an ink of any color, or may be a colorless ink, but from the viewpoint of effectively obtaining the effects of the invention, the ink is preferably colored, and is more preferably at least one of a magenta ink, a cyan ink, a yellow ink, or a black ink.

For example, it is preferred that the ink in the invention be an ink prepared by dissolving or dispersing a betaine compound and a coloring material (a dye or the like) in water and a water soluble organic solvent. Above all, it is more preferred that the ink in the invention be an aqueous solution type ink containing a water soluble dye.

In particular, in the inkjet recording method of the invention, an embodiment in which the ink containing 0.1% by mass to 1.0% by mass of a betaine compound is a magenta ink is preferable.

Namely, an embodiment in which images are formed by using an ink set which includes a magenta ink containing 0.1% by mass to 1.0% by mass of a betaine compound is preferable.

By taking the above embodiment, it is possible to improve the magenta image density.

As the magenta ink, for example, an ink containing the magenta dye described later may be used.

Furthermore, another embodiment in which images are formed by using an ink set which includes a cyan ink containing 0.1% by mass to 1.0% by mass of a betaine compound is also preferable. By taking this embodiment, it is possible to further suppress the high-humidity blurring at a gray image portion.

From the reason mentioned above, it is also preferred to form images using an ink set which includes a cyan ink containing 0.1% by mass to 1.0% by mass of a betaine compound and a magenta ink containing 0.1% by mass to 1.0% by mass of a betaine compound.

<Coloring Material>

The ink according to the invention is preferably prepared by including at least one coloring material in addition to the betaine compound described above.

As the coloring material, known dyes, pigments and the like may be used without any particular limitation.

The pigment is not particularly limited and can be suitably selected depending on the purposes, and for example, either of an organic pigment or an inorganic pigment may be used.

Examples of the organic pigment include an azo pigment, a polycyclic pigment, a dye chelate, a nitro pigment, a nitroso pigment, and aniline black. Among them, an azo pigment and a polycyclic pigment are preferable. Examples of the azo pigment include azo lake, insoluble azo pigment, condensed azo pigment, and chelate azo pigment. Examples of the polycyclic pigment include a phthalocyanine pigment, a perylene pigment, a perynone pigment, an anthraquinone pigment, a quinacridone pigment, a dioxazine pigment, an indigo pigment, a thioindigo pigment, an isoindolinone pigment, and a quinophthalone pigment. Examples of the dye chelate include a basic dye chelate and an acid dye chelate.

Examples of the inorganic pigment include titanium oxide, iron oxide, calcium carbonate, barium sulfate, aluminum hydroxide, barium yellow, cadmium red, chrome yellow, and carbon black. Among them, carbon black is particularly preferable. As the carbon black mentioned above, those manufactured by a known method such as a contact method, a furnace method, or a thermal method may be mentioned.

The dye is not particularly limited and can be suitably selected depending on the purposes, and for example, dyes classified in the color index as acid dyes, direct dyes, reactive dyes, vat dyes, sulfur dyes, or food dyes, as well as oil dyes and basic dyes may be used.

Further, dyes having an oxidation potential of higher than 1.0 V, which are described in paragraphs [0051] to [0054] in JP-A No. 2005-111699, may also be used as the dye.

Examples of representative dyes include azo dyes, azomethine dyes, xanthene dyes, and quinone dyes. Furthermore, as the magenta dye, cyan dye, yellow dye, and black dye, the dyes described below are preferable.

(Magenta Dye)

Examples of the magenta dye include aryl or heterocyclic azo dyes having, for example, phenols, naphthols, or anilines, as a coupler component; azomethine dyes having, for example, pyrazolones, or pyrazolotriazoles, as a coupler component; methine dyes such as an arylidene dye, a styryl dye, a merocyanine dye, a cyanine dye, and an oxonol dye; carbonium dyes such as a diphenylmethane dye, a triphenylmethane dye, and a xanthene dye; quinone dyes such as naphthoquinone, anthraquinone, and anthrapyridone; and condensed polycyclic dyes such as a dioxazine dye, while the scope of the invention is not limited thereto.

As the magenta dye, a heterocyclic azo dye is preferable, and examples thereof include those described in International Patent Publication Nos. 2002/83795 (pages 35 to 55), and 2002/83662 (pages 27 to 42), and JP-A Nos. 2004-149560 (paragraphs [0046] to [0059]), 2004-149561 (paragraphs [0047] to [0060]), and 2007-70573 ((paragraphs [0073] to [0082]). Among them, form the viewpoints of ozone resistance and light fastness, a compound represented by the following Formula (M) is more preferable.

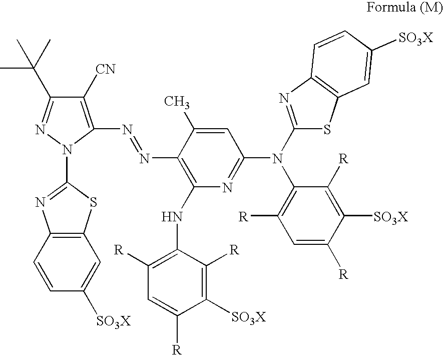

In Formula (M), the plural Rs each independently represent a methyl group, an ethyl group, an isopropyl group, or a tert-butyl group, and X represents Li, Na, or K. Each R may be the same as or different from another R. Each X may be the same as or different from another X.

Specific examples of the compound represented by Formula (M) are shown below, but the invention is not limited to these examples.

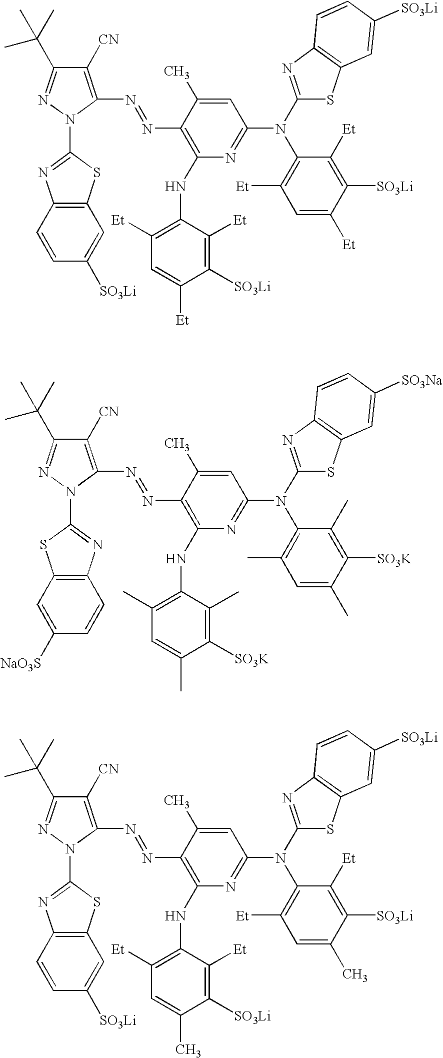

Moreover, as the magenta dye in the invention, magenta dyes described in paragraphs [0196] to [0281] in JP-A No. 2005-111699 are also preferable.

(Cyan Dye)

Examples of the cyan dye include aryl or heterocyclic azo dyes having, for example, phenols, naphthols, or anilines, as a coupler component; azomethine dyes having, for example, phenols, naphthols, or heterocycles such as pyrrolotriazole, as a coupler component; polymethine dyes such as a cyanine dye, an oxonol dye, and a merocyanine dye; carbonium dyes such as a diphenylmethane dye, a triphenylmethane dye, and a xanthene dye; phthalocyanine dyes; anthraquinone dyes; and indigo-thioindigo dyes, while the scope of the invention is not limited thereto.

As the cyan dye, an associative phthalocyanine dye is preferable, and examples thereof include those described in International Patent Publication Nos. 2002/60994, 2003/811, and 2003/62324, and JP-A Nos. 2003-213167, 2004-75986, 2004-323605, 2004-315758, 2004-315807, 2005-179469, and 2007-70573 (paragraphs [0083] to [0090]). Specifically, form the viewpoints of ozone resistance and light fastness, a compound represented by the following structural formula is preferable.

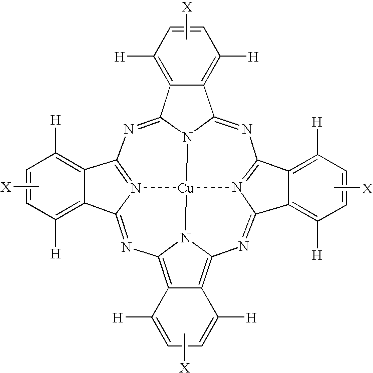

The compound in which, from among four Xs in the above structural formula, three Xs are each a —SO₂(CH₂)₃SO₃Li group and one X is a —SO₂(CH₂)₃SO₂NHCH₂CH(CH₃)OH group is preferable.

Further, the compound in which, from among four Xs in the above structural formula, two Xs are each a —SO₂(CH₂)₃SO₃Li group and two Xs are each a —SO₂(CH₂)₃SO₂NHCH₂CH(CH₃)OH group is also preferable.

Moreover, as the cyan dye in the invention, phthalocyanine dyes described in paragraphs [0108] to [0195] in JP-A No. 2005-111699 are also preferable.

(Yellow Dye)

Examples of the yellow dye include those described in International Patent Publication No. 2005/075573, JP-A Nos. 2004-83903 (paragraphs [0024] to [0062]), 2003-277661 (paragraphs [0021] to [0050]), 2003-277262 (paragraphs [0042] to [0047]), 2003-128953 (paragraphs [0025] to [0076]), and 2003-41160 (paragraphs [0028] to [0064]), and U.S. Patent Application Publication No. 2003/0213405 (paragraph [0108]); C.I. Direct Yellow Nos. 8, 9, 11, 12, 27, 28, 29, 33, 35, 39, 41, 44, 50, 53, 59, 68, 86, 87, 93, 95, 96, 98, 100, 106, 108, 109, 110, 130, 132, 142, 144, 161, and 163; C.I. Acid Yellow Nos. 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227; C.I. Reactive Yellow Nos. 2, 3, 13, 14, 15, 17, 18, 23, 24, 25, 26, 27, 29, 35, 37, 41, and 42; C.I. Basic Yellow Nos. 1, 2, 4, 11, 13, 14, 15, 19, 21, 23, 24, 25, 28, 29, 32, 36, 39, and 40; and the like. Further, yellow dyes described in paragraphs [0013] to [0112] and [0114] to [0121] in JP-A No. 2007-191650 are preferable. Above all, from the viewpoints of ozone resistance and light fastness, a compound represented by the following Formula (Y) is preferable.

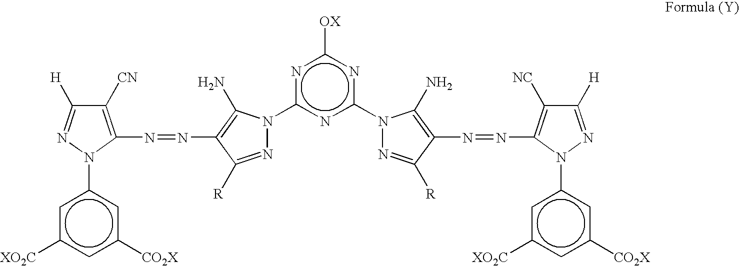

In Formula (Y), R represents a methyl group, an ethyl group, an isopropyl group, or a tert-butyl group, and X represents K, Na, or Li. In Formula (Y), each R may be the same as or different from another R. Each X may be the same as or different from another X.

Specific example of the compound represented by Formula (Y) is shown below, but the invention is not limited to this example.

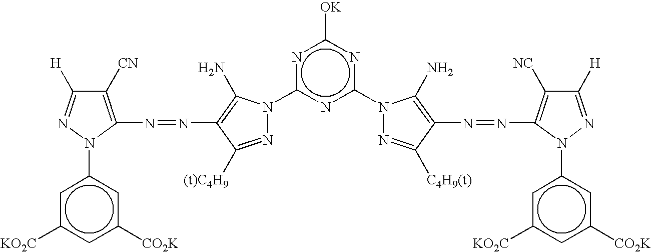

Moreover, as the yellow dye in the invention, yellow dyes described in paragraphs [0056] to [0107] in JP-A No. 2005-111699 are also preferable.

(Black Dye)

Examples of the black dye include disazo dyes, trisazo dyes, and tetrakisazo dyes. These black dyes may be used in combination with a pigment such as a dispersion of carbon black or the like.

Preferable examples of the black dye are described in detail in JP-A Nos. 2005-307177 and 2006-282795 (paragraphs [0068] to [0087]). Specifically, compounds of the following structural formulae are preferable in view of ozone resistance and light fastness.

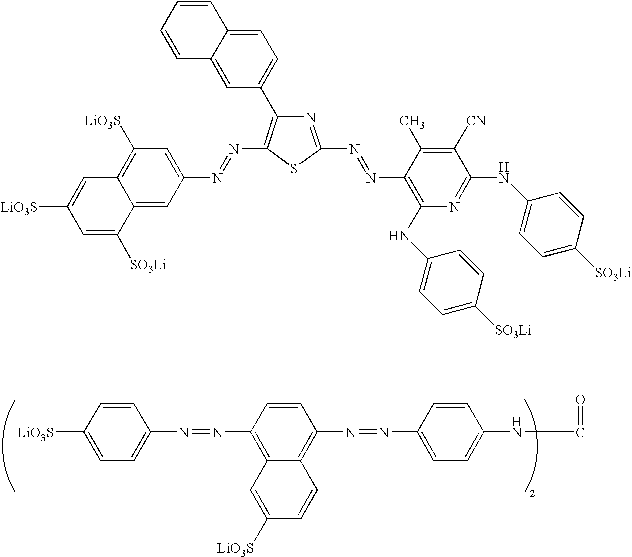

Moreover, as the black dye in the invention, black dyes described in paragraphs [0282] to [0360] in JP-A No. 2005-111699 are also preferable.

<Other Components>

The ink according to the present invention may include other components in addition to the betaine compound and the coloring material.

As the other components, solvent components such as organic solvents having a high boiling point, various surfactants, drying inhibitors, penetration accelerators, ultraviolet absorbers, antioxidants, viscosity adjusting agents, surface tension adjusting agents, dispersing agents, dispersion stabilizers, mildew-proofing agents, anti-rust agents, pH adjusting agents, defoaming agents, and the like can be mentioned.

Concerning the other components and preparation method of inks, components and methods described, for example, in paragraphs [0047] to [0050] and [0375] to [0410] in JP-A No. 2005-111699 may also be used for the present invention.

### EXAMPLES

The present invention will be further described below in detail with reference to the examples, but it should be construed that the invention is in no way limited to these examples as long as not departing from the scope of the present invention. Note that, the terms “part”, “%”, and “molecular weight” respectively refer to as “part by mass”, “% by mass”, and “weight average molecular weight”, unless otherwise noted.

### Example 1

### Preparation of Magenta Ink

To the components (solids and liquid components) described below was added ultra-pure water having a resistance value of equal to or higher than 18 MΩ to give a total volume of 1 liter (L), and then, the mixture was stirred for one hour while heating at 30° C. to 40° C.

Thereafter, the resultant was filtered under reduced pressure using a micro filter having an average pore diameter of 0.25 μm to prepare a magenta ink.

<Magenta Ink Composition>

| | |
|---|---|
| Magenta dye (M-1 described below) | 33 g |
| Urea (UR) | 15 g |
| PROXEL XL-2 (trade name) | 5 g |

Betaine compound (exemplified compound X1-3 described above)
   in an amount to be 1.0% by mass with respect to the total mass of magenta ink

| | |
|---|---|
| Diethylene glycol | 90 g |
| Glycerin | 150 g |
| Triethylene glycol monobutyl ether | 100 g |
| Triethanol amine | 8 g |
| SURFYNOL STG (trade name) | 10 g |

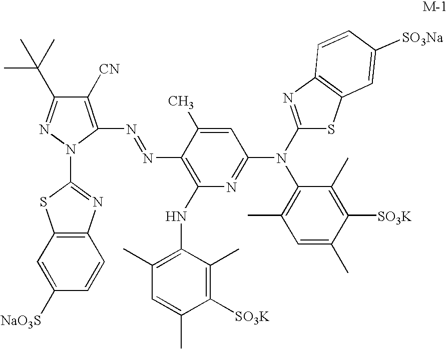

<<Preparation of Inkjet Recording Medium>>

<Preparation of Support>

Wood pulp made of 100 parts of LBKP was beaten to give a Canadian freeness of 300 mL using a double disc refiner, and then, to the resultant were added 0.5 parts of epoxidized behenic acid amide, 1.0 parts of anionic polyacrylamide, 0.1 parts of polyamide polyamine epichlorohydrin, and 0.5 parts of cationic polyacrylamide, in terms of absolute dry mass ratio with respect to the pulp. The resulting mixture was subjected to sheet forming using a Fourdrinier paper machine to obtain a base paper having a basis weight of 170 g/m².

For the purpose of adjusting the surface size of the base paper, the base paper was immersed in a solution prepared by adding 0.04% of a fluorescent whitening agent (“WHITEX BB” (trade name), manufactured by Sumitomo Chemical Co., Ltd.) in a 4% aqueous solution of polyvinyl alcohol so that the base paper contained 0.5 g/m² of the solution in terms of absolute dry mass, and then dried. After drying, the resulting paper was further subjected to calender treatment, thereby obtaining a substrate paper adjusted to have a density of 1.05 g/mL.

After the wire face (rear face) side of the obtained substrate paper was subjected to corona discharge treatment, high density polyethylene was coated thereon in a thickness of 19 μm using a melt extruder to form a resin layer having a matte surface (hereinafter, the resin layer face is referred to as the rear face). The resin layer formed on the rear side was further subjected to corona discharge treatment, and thereafter, a dispersion prepared by dispersing aluminum oxide (“ALUMINASOL 100” (trade name), manufactured by Nissan Chemical Industries, Ltd.) and silicon dioxide (“SNOWTEX O” (trade name), manufactured by Nissan Chemical Industries, Ltd.), as antistatic agents, in water at a mass ratio of 1:2 was coated so that the dry mass thereof became 0.2 g/m².

Furthermore, after the felt face (front face) side of the substrate paper on which a resin layer was not provided was subjected to corona discharge treatment, low density polyethylene containing 10% of anatase type titanium dioxide, a slight amount of ultramarine blue pigment, and 0.01% of a fluorescent whitening agent (with respect to polyethylene) and having an MFR (melt flow rate) of 3.8 was extruded thereon in a thickness of 29 μm using a melt extruder. Thereby, a thermoplastic resin layer with high glossiness was formed on the front face side of the substrate paper (hereinafter, the high glossy face is referred to as “the front face”). In this way, a support was obtained.

<Preparation of Coating Liquid A for Ink Receiving Layer>

Among the components in the composition shown below, (1) vapor-phase process silica, (2) ion exchanged water, (3) water soluble polymer, and (4) zirconyl acetate were mixed and roughly dispersed using a suction disperser (“CONTI-TDS” (trade name), manufactured by DALTON Corporation). The resulting coarse particle dispersion liquid was further subjected, to dispersion to be finely dispersed using a high pressure homogenizer (“ULTIMIZER (trade name), manufactured by Sugino Machine Limited) under a pressure of 120 MPa. The resulting fine particle dispersion liquid was stored under a liquid temperature of 45° C. for 20 hours. After that, to the dispersion liquid, a solution containing the following (5) polyvinyl alcohol, (6) boric acid, (7) ion exchanged water, and (8) surfactant was added and stirred, whereby a coating liquid A for an ink receiving layer was prepared.

The mass ratio of vapor-phase process silica to polyvinyl alcohol [PB ratio=(1): (4)] was 5:1.

—Composition of Coating Liquid A for Ink Receiving Layer—

| | | |
|---|---|---|
| (1) | Vapor-phase process silica (“AEROSIL 300SF75” | 8.92 parts |
| | (trade name), manufactured by Nippon Aerosil Co., | |
| | Ltd.; average primary particle diameter of 7 nm) | |
| (2) | Ion exchanged water | 33.80 parts |
| (3) | Water soluble polymer, 51.5% aqueous solution | 0.78 parts |
| | (dispersing agent) (“SHALLOL DC902P” (trade | |
| | name), manufactured by Dai-ichi Kogyo Seiyaku | |
| | Co., Ltd.) | |
| (4) | Zirconyl acetate (inorganic mordant), 50% aqueous | 0.36 parts |
| | solution (“ZIRCOSOL ZA-30” (trade name), | |
| | manufactured by Daiichi Kigenso Kagaku Kogyo | |
| | Co., Ltd.) | |
| (5) | Polyvinyl alcohol, 7% aqueous solution (water | 25.98 parts |
| | soluble resin) (“PVA 235” (trade name), | |
| | manufactured by Kuraray Co., Ltd.; saponification | |
| | degree of 88%, and polymerization degree of 3500) | |
| (6) | Boric acid, 7.5% aqueous solution (crosslinking agent) | 5.28 parts |
| (7) | Ion exchanged water | 22.16 parts |
| (8) | Surfactant, 10% aqueous solution (“EMULGEN 109P” | 0.60 parts |
| | (trade name), manufactured by Kao Corporation) | |

<Preparation of Inkjet Recording Medium>

After the front face of the support was subjected to corona discharge treatment, the coating liquid A for an ink receiving layer was coated on the front face in the following manner using an extrusion die coater.

Specifically, the coating liquid A for an ink receiving layer and the inline liquid described below were inline-mixed and then coated on the support at rates (coating amounts) respectively of 178.6 g/m² and 10 g/m² to form a layer. Subsequently, the coated layer was dried at 80° C. using a hot air dryer (at an air flow rate of 3 m/sec to 8 m/sec) until the solid matter concentration of the coated layer became 20%. The coated layer exhibited constant-rate drying during this period.

Immediately after the process, the resulting support having thereon the coated layer was immersed in a coating liquid B for an ink receiving layer having the following composition for 30 seconds to apply the coating liquid B for an ink receiving layer in an amount of 10 g/m² onto the coated layer, and then further dried at 80° C. for 10 minutes. Thus, an ink receiving layer, in which the coating liquid B for an ink receiving layer was applied on the coated layer that had been dried, was obtained. The ink receiving layer had a dry thickness of 32 μm.

In this way, an inkjet recording medium having, on a support, an ink receiving layer was prepared.

—Composition of Inline Liquid—

| | | |
|---|---|---|
| (1) | ALFINE 83 | 2.0 parts |
| | (trade name, manufactured by Taimei Chemicals | |
| | Co., Ltd., polyaluminum chloride aqueous solution) | |
| (2) | Ion exchanged water | 7.8 parts |
| (3) | HYMAX SC-507 | 0.2 parts |
| | (trade name, manufactured by HYMO Co., Ltd.; | |
| | polycondensate of dimethylamine and epichlorohydrin) | |

—Composition of Coating Liquid B for Ink Receiving Layer—

| | | |
|---|---|---|
| (1) | Betaine compound (exemplified compound X1-3 | 4.0 parts |
| | described above), 20% aqueous solution | |
| (2) | Ion exchanged water | 34.0 parts |
| (3) | Ammonium carbonate (pH adjusting agent) | 2.0 parts |

The pH of the coating liquid B for an ink receiving layer was 7.9. The pH was measured at 30° C. using a pH meter WM-50EG (trade name, manufactured by DKK-Toa Corporation) and using the solution in the form of stock solution.

In the ink receiving layer formed as described above, the amount of zirconyl acetate (in terms of ZrO₂) was 0.2 g/m² and the amount of the exemplified compound X1-3 was 0.2 g/m².

<<Inkjet Recording and Evaluation>>

Among the inks of the genuine ink set (which is an ink set constituted of a cyan ink, magenta ink, yellow ink, and black ink) for DRY MINILAB DL410 (trade name, manufactured by FUJIFILM Corporation), the magenta ink was replaced with the magenta ink prepared above, thereby preparing an ink set for evaluation.

This ink set for evaluation was loaded into a DRY MINILAB DL410 (trade name, manufactured by FUJIFILM Corporation), and inkjet recording was performed with respect to the inkjet recording medium prepared above, followed by performing the evaluation described below.

Results of the evaluation are shown in Table 1 described below.

<High-Humidity Blurring>

Using the DRY MINILAB DL410 (trade name, manufactured by FUJIFILM Corporation) mounted with the ink set for evaluation, an image was printed on the inkjet recording medium prepared above in such a manner that the density changed stepwise to exhibit a gradation of eight grades with regard to six colors of C, M, Y, B, G, and R and gray.

The obtained image was stored under conditions of 23° C. and 90% RH for 14 days.

After the storage, the image was visually observed, and evaluated according to the following evaluation criteria.

—Evaluation Criteria—
A: no blurring to the background portion is observed.
B: blurring to the background portion is slightly observed, that is practically acceptable.
C: remarkable blurring to the background portion is observed, that is practically unacceptable.

<Printing Defects>

Using the DRY MINILAB DL410 (trade name, manufactured by FUJIFILM Corporation) mounted with the ink set for evaluation, a magenta solid image was printed on the inkjet recording medium prepared above.

The magenta solid image thus printed was visually observed, the existence or absence of printing defects which were supposed to be caused by foaming of ink was observed, and the printing defects were evaluated according to the following criteria.

—Evaluation Criteria—
A: no printing defect is observed.
B: printing defects are slightly observed, that is practically acceptable.
C: remarkable printing defects are observed, that is practically unacceptable.

<Coating Failure>

The surface of the ink receiving layer of the above inkjet recording medium was visually observed, the existence or absence of coating failure was observed, and the coating failure was evaluated according to the following criteria.

—Evaluation Criteria—
A: no coating failure is observed.
B: coating failure is slightly observed, that is practically acceptable.
C: remarkable coating failure is observed, that is practically unacceptable.

<Ozone Resistance (Cyan)>

Using the DRY MINILAB DL410 (trade name, manufactured by FUJIFILM Corporation) mounted with the ink set for evaluation, a cyan solid image was printed on the inkjet recording medium prepared above.

Next, the inkjet recording medium on which the cyan solid image was printed was left for seven days in a box, wherein the air inside the box was set to have an ozone gas concentration of 10 ppm.

The image density was measured before and after leaving the medium in the ozone gas atmosphere using a reflection densitometer (X-RITE 310TR; trade name) to determine the cyan dye remaining ratio. The ozone resistance (cyan) was evaluated according to the following criteria.

Incidentally, the reflection density was measured at three points where the densities were 1, 1.5, and 2.0, respectively. The ozone gas concentration inside the box was set by means of an ozone gas monitor (model: OZG-EM-01; trade name) manufactured by APPLICS.

—Evaluation Criteria—
A: the dye remaining ratio is 80% or higher at all of the three points.
B: the/dye remaining ratio is lower than 80% at one point or two points.
C: the dye remaining ratio is lower than 70% at all of the three points.

<Image Density (Magenta)>

Using the DRY MINILAB DL410 (trade name, manufactured by FUJIFILM Corporation) mounted with the ink set for evaluation, a magenta solid image was printed on the inkjet recording medium prepared above.

The image density of the magenta solid image was measured by means of GRETAG SPECTROLINO SPM-50, under conditions of angle of visibility of 2°, light source of D50, and no filter, and evaluated according to the following criteria.

—Evaluation Criteria—
A: image density is 2.5 or more.
B: image density is 2.2 or more but less than 2.5.
C: image density is less than 2.2.

### Examples 2 to 7, and Comparative Examples 1 to 6

Inkjet recording and evaluation were conducted in a manner substantially similar to that in Example 1, except that, in Example 1, the kind and/or the amount of the betaine compound and the amount of the inorganic mordant in the ink receiving layer, and the kind and/or the amount of the betaine compound in the magenta ink were changed as shown in the following Table 1.

The obtained evaluation results are shown in the following Table 1.

TABLE 1

| | Ink Receiving Layer | | | | | | | | | | |
|---|---|---|---|---|---|---|---|---|---|---|---|
| | Betaine compound | | Inorganic Mordant | | Magenta Ink | | | | | | |
| | | Coating | | Coating | Betaine compound | | | Ozone | | | Image |
| | | Amount | | Amount | | Content | High-humidity | Resistance | Printing | Coating | Density |
| | Kind | (g/m²) | Kind | (g/m²) | Kind | (%) | Blurring | (Cyan) | Defects | Failure | (Magenta) |
| Example 1 | X1-3 | 0.2 | ZA-30 | 0.2 | X1-3 | 0.5 | A | A | A | A | A |
| Example 2 | X1-3 | 0.2 | ZA-30 | 0.2 | X1-3 | 0.9 | A | A | B | A | B |
| Example 3 | X1-3 | 0.4 | ZA-30 | 0.2 | X1-3 | 0.9 | A | B | B | B | B |
| Example 4 | X1-3 | 0.2 | ZA-30 | 0.4 | X1-3 | 0.5 | A | A | A | B | A |
| Example 5 | X1-29 | 0.2 | ZA-30 | 0.4 | X1-3 | 0.5 | B | A | A | B | A |
| Example 6 | X1-3 | 0.2 | ZA-30 | 0.4 | X1-29 | 0.5 | B | A | B | B | A |
| Example 7 | X1-3 | 0.2 | ZA-30 | 0.2 | X1-3 | 0.2 | A | A | A | A | A |
| Comparative | X1-3 | 0.7 | ZA-30 | 0.2 | X1-3 | 0.5 | A | C | A | C | A |
| Example 1 | | | | | | | | | | | |
| Comparative | X1-3 | 0.2 | ZA-30 | 0.2 | X1-3 | 1.5 | A | B | C | A | C |
| Example 2 | | | | | | | | | | | |
| Comparative | X1-3 | 0.4 | ZA-30 | 0.2 | X1-3 | 1.5 | A | C | C | B | C |
| Example 3 | | | | | | | | | | | |
| Comparative | X1-3 | 0.7 | ZA-30 | 0.2 | X1-3 | 1.5 | A | C | C | C | C |
| Example 4 | | | | | | | | | | | |
| Comparative | X1-3 | 0.2 | none | — | X1-3 | 0.5 | C | A | A | A | A |
| Example 5 | | | | | | | | | | | |
| Comparative | X1-3 | 0.2 | ZA-30 | 0.6 | X1-3 | 0.5 | A | A | A | C | A |
| Example 6 | | | | | | | | | | | |

As is shown in Table 1, in Examples 1 to 7, where an image is recorded on an inkjet recording medium having an ink receiving layer containing 0.05 g/m² to 0.5 g/m² of a betaine compound and 0.1 g/m² to 0.5 g/m² of an inorganic mordant using a magenta ink containing 0.1% by mass to 1.0% by mass of a betaine compound, high-humidity blurring is suppressed and printing defects and coating failure are suppressed. Further, in Examples 1 to 7, ozone resistance of the cyan image is excellent and magenta image density is high.

On the contrary, in Comparative example 1, where the amount of the betaine compound in the ink receiving layer exceeds 0.5 g/m², failure in coating of the ink receiving layer and ozone resistance of the cyan image are deteriorated.

Further, in Comparative examples 2 to 4, where the amount of the betaine compound in the ink exceeds 1.0% by mass, printing defects and magenta image density are deteriorated.

Further, in Comparative example 5, where an inorganic mordant is not added to the ink receiving layer, high-humidity blurring is deteriorated.

Furthermore, in Comparative example 6, where the amount of the inorganic mordant in the ink receiving layer exceeds 0.5 g/m², coating failure is deteriorated.

In addition, in all of the examples and comparative examples, odor was not particularly recognized.

In the examples above, 0.1% by mass to 1.0% by mass of a betaine compound is added to the magenta ink, however the ink to which 0.1% by mass to 1.0% by mass of a betaine compound is to be added is not limited to the magenta ink.

For example, even in the case where 0.1% by mass to 1.0% by mass of a betaine compound is added to the cyan ink, yellow ink, or black ink, high-humidity blurring, printing defects, and coating failure are suppressed, and ozone resistance of a cyan image is improved, similar to the case of the above Examples.

According to the present invention, an inkjet recording method with which high-humidity blurring is suppressed and printing defects and coating failure are suppressed is provided.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling other's skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An inkjet recording method comprising:
recording an image, by an inkjet method using at least an ink comprising from 0.1% by mass to 1.0% by mass of a betaine compound, on an inkjet recording medium comprising, on a support, an ink receiving layer comprising from 0.05 g/m² to 0.5 g/m² of a betaine compound and from 0.1 g/m² to 0.5 g/m² of an inorganic mordant.

2. The inkjet recording method of claim 1, wherein the ink is a magenta ink.

3. The inkjet recording method of claim 1, wherein each of the betaine compound included in the ink receiving layer and the betaine compound included in the ink is a betaine surfactant comprising an oil-soluble group.

4. The inkjet recording method of claim 1, wherein a cationic moiety of the betaine compound included in the ink receiving layer and a cationic moiety of the betaine compound included in the ink each comprises a nitrogen atom of amine, a nitrogen atom of a hetero-aromatic ring, a quaternary nitrogen atom, a boron atom that has four bonds each connected with a carbon atom, or a phosphorous atom that has four bonds each connected with a carbon atom.

5. The inkjet recording method of claim 1, wherein the betaine compound included in the ink receiving layer and the betaine compound included in the ink are each compounds represented by the following Formula (B1): 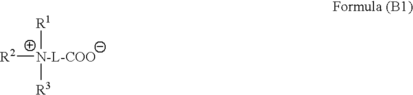
wherein, in Formula (B1), R¹, R² and R³ each independently represents an alkyl group, an aryl group or a heterocyclic group; R¹ to R³ are capable of linking together to form a cyclic structure; and L represents a bivalent linkage group.

6. The inkjet recording method of claim 1, wherein the betaine compound included in the ink receiving layer and the betaine compound included in the ink are each compounds represented by the following Formula (B2): 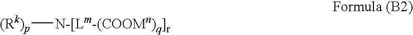
wherein, in Formula (B2), R^{k} represents an unsubstituted or substituted alkyl group having 1 to 20 carbon atoms, an unsubstituted or substituted aryl group having 6 to 20 carbon atoms or an unsubstituted or substituted heterocyclic group having 2 to 20 carbon atoms; (R^{k})s are capable of linking together to form a cyclic structure; L^{m} represents a bivalent linkage group; Mⁿ represents a hydrogen atom, an alkali metal ion, an ammonium ion, an organic cation of amine or a quaternary ammonium ion; p is an integer of 0 to 3; q is an integer of 1 or more; r is an integer of 1 to 4; and p+r is 3 or 4.

7. The inkjet recording method of claim 6, wherein a group represented by R^{k} or L^{m} comprises a hydrocarbon group having 8 to 20 carbon atoms.

8. The inkjet recording method of claim 1, wherein the inorganic mordant is a compound including aluminum, a compound including titanium, a compound including zirconium or a metal compound including an element belonging to Group IIIB of the periodic table.

9. The inkjet recording method of claim 1, wherein the inorganic mordant is a water soluble zirconium compound.

10. The inkjet recording method of claim 2, wherein the magenta ink comprises a dye represented by the following Formula (M): 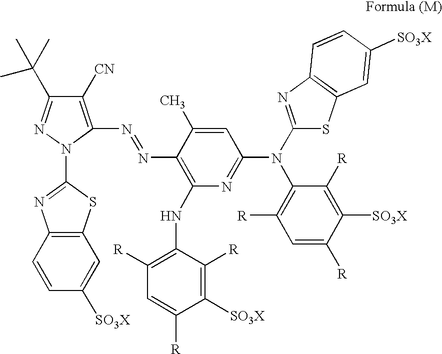
wherein, in Formula (M), R represents a methyl group, an ethyl group, an isopropyl group or a tert-butyl group; X represents Li, Na or K; each R may be the same as or different from another R; and each X may be the same as or different from another X.
